(19) United States
(12) Patent Application Publication
(10) Pub. No.: US 2022/0177237 A1
(43) Pub. Date: Jun. 9, 2022

(54) COMPONENT HANDLING DEVICE FOR COMPONENT HANDLING, AND INJECTION-MOULDING MACHINE EQUIPPED THEREWITH

(71) Applicant: Sumitomo (SHI) Demag Plastics Machinery GmbH, Schwaig (DE)

(72) Inventor: Jürgen SCHULZE, Altdorf (DE)

(73) Assignee: Sumitomo (SHI) Demag Plastics Machinery GmbH, Schwaig (DE)

(21) Appl. No.: 17/594,384

(22) PCT Filed: Apr. 7, 2020
(86) PCT No.: PCT/EP2020/059925

§ 371 Date: Oct. 14, 2021

(30) Foreign Application Priority Data
Apr. 25, 2019 (DE) 10 2019 205 940.6

(51) Int. Cl. B65G 47/90

(52) U.S. Cl. CPC B65G 47/90

(57) ABSTRACT

A component handling device for component handling in working or process machines, in particular injection moulding machines, comprises
a basic linear axis running outside or inside the handling space of the handling device,
a multi-axis arrangement, which is translationally displaceable on the basic linear axis, with
   a main rotational axis orthogonal to the basic linear axis,
   a secondary rotational axis directed parallel thereto and linked to the main rotational axis via a first robot arm, which guides a second robot arm pivotably over the handling space, and
   a vertical linear axis linked to the second robot arm eccentrically to the secondary rotational axis, and
a gripping device linked to the vertical linear axis for a component to be handled.

### CROSS-REFERENCES TO RELATED APPLICATIONS

This application is a national stage application, filed under 35 U.S.C. § 371, of International Patent Application No. PCT/EP2020/059925, filed on Apr. 7, 2020, which claims the priority of German Patent Application, Serial No. 10 2019 205 940.6, filed Apr. 25, 2019, the content of which is incorporated herein by reference in its entirety as if fully set forth herein.

### FIELD OF THE INVENTION

The invention relates to a component handling device for component handling in working or process machines, such as injection moulding machines, and to an injection moulding machine equipped therewith.

### BACKGROUND OF THE INVENTION

The problem of the prior art underlying the invention is to be explained in more detail using the example of an injection moulding machine. Currently common handling devices for component removal in injection moulding machines, such as are currently also used by the applicant, are generally based on 4-axis linear robots which have three translational axes and at least one, but also up to three rotational axes. Such a handling device, as is also known, for example, as a gantry robot for supplying machine tools with tools and workpieces from DE 41 27 446 A1, is shown in FIG. 8 in an application in which the handling device 1′ is mounted on the fixed tool clamping plate 2 of an injection moulding machine. Of this injection moulding machine, only the movable clamping plate 3 of the clamping unit is shown without a toggle lever, and of the injection unit, only the nozzle connection 4 of the plasticising cylinder is shown. In the following, both in the description of the prior art and of the invention, the corresponding axes will be denoted by “T^{x}” and “R^{x}” respectively—T: translational axis, R rotational axis, x: Position of the axis in the kinematic chain. Thus, for example, the 4-axis arrangement explained above is denoted by axes T¹T²T³R¹ as drawn in FIG. 6. The translational axes serve to change the position of the gripping tool 5′ for the handling component BT in space, while the rotational axis/axes R¹ serve to change its orientation, for example to remove the component BT positioned upright in the open injection moulding tool and deposit it on a horizontal carrier 6′. These handling devices are configured above the injection moulding machine and have a cubic working space.

The aforementioned type of handling device has various disadvantages. For example, the three translational axes T¹T²T³ are generally designed as open guides with a so-called loss lubrication, which entails a high risk of contamination of the tool or the components manufactured therein. This is particularly true for the two axes of the handling device 1′ which are cyclically located directly above and/or in the tool and component depositing region. In order to achieve at least five degrees of freedom of these handling devices, two additional rotational axes R¹R² are required, which are arranged at the end of the kinematic chain consisting of the three linear axes T¹T²T³, that is to say at the third translational axis T³. These two rotational axes R¹R² must therefore be moved along with each movement of the third translational axis T³ in the earth gravity field, which leads to a high energy input with a correspondingly unfavourable energy balance.

Furthermore, the arrangement of the rotational axis/axes on the third linear axis leads to an increased tendency to oscillation due to a pendulum effect, which may have to be counteracted by a payload reduction on the third translational axis.

If, in such a linear robot, the second translational axis T² is designed as a rigid boom 7′ which can be moved on the first translational axis T¹ and on which the third translational axis T³ moves vertically, there is a considerable risk of collision with this boom 7′ when the component is removed from the open injection moulding tool, in particular for components which are long in the vertical direction. Such a collision situation between the hatched elongated component BT and this boom 7′ is shown in FIG. 8.

Furthermore, the limited cubic robot working space of this handling device 1′ remains unchanged by adding further rotational degrees of freedom, thus cannot be enlarged thereby, since only the orientation of the gripping tool is changed by these rotational degrees of freedom.

In another prior art, as given by the obvious prior use of the company Automations-und Qualitätssysteme AG, Bendererstrasse 33, 9494 Schaan, FL in the form of the handling device “AQS-P 120 rotary arm robot”, a kinematic chain is formed from a translational axis, a rotational axis rotatably arranged thereon, a second translational axis arranged thereon in an orthogonal direction to the first translational axis, and at least two further rotational axes on the second translational axis. In brief, this arrangement is thus to be indicated by T¹R¹T²R²R³.

Here, similar disadvantages arise as with the first-mentioned arrangement T¹T²T³R¹. The replacement of the second translational axis T² there by the two parallel rotational axes Wand R² in front of and behind the translational axis T² has the effect that, due to the arrangement of the second rotational axis R² on the vertical translational axis T², comparatively high masses must again be moved, which has a detrimental effect on the vibration behaviour, energy balance and component load-bearing capacity of the arrangement. Furthermore, with this arrangement, a rotation of R² alone only causes a change in the orientation of the gripping tool, but no change in the position in space.

Further handling devices, in particular for the use with a moulding machine, are shown in DE 10 2014 014 265 A1 or US 2012/0294961 A1. In these known devices, an axis arrangement with a translational, horizontal base axis T¹, two rotational axes R^{1 v}and R² directed parallel thereto and a translational vertical axis T² is used. In the first-mentioned document, the axis order is T¹R¹R²T², and in the second-mentioned document, T¹T²R¹R². Both designs have in common that the two rotational axes R¹R² are forcibly coupled about a horizontal axis for position and orientation adjustment of the object to be gripped, thus in this respect no real separate degrees of freedom are created by the two rotational axes. In addition, the handling space that can be covered by these handling devices is severely limited to the cantilever side of the boom that can be pivoted about the rotational axes.

Another known handling device, such as is known in principle from U.S. Pat. No. 5,802,201 A, for example, is based on a so-called SCARA robot, in which two successive, parallel rotational axes R¹ and R² are followed by a translational axis T¹, which can be displaced parallel to these axes, and at least one further rotational axis R³ thereon. In this case, the translational axis T¹ is centric to the third rotational axis R³, which necessitates the use of circular guides and ball bearing screws for the movement of these two axes, and these guide and drive elements are now well suited for axial loads, but react in a mechanically sensitive manner to radial loads and impacts, such as occur in particular during component handling in injection moulding tools. Furthermore, the mechanical stiffnesses, travelling distances and speeds that can be achieved or are required for the axis T¹ are probably insufficient for the use in injection moulding machines.

As further prior art, reference should be made to CN 108 544 482 A1, in which a linear vertical axis of a SCARA robot is driven by a chain instead of the usual design with a ball bearing screw.

In the SCARA robot known from US 2017/0239810 A1, the first arm of the robot can be lengthened or shortened as desired by using connectors. This allows the arms of the SCARA robot to have different lengths.

The handling devices according to the two above-mentioned documents do not provide any starting points for improvement with regard to the problems described in connection with component handling in injection moulding machines.

The discussion of the state of the art should be concluded with a reference to the possibility of using complex 6-axis industrial robots for the component handling. These have a spherical working space and offer a wide range of payloads. However, in order to have comparable working spaces to a linear robot, these robots must be relatively large in terms of their range, which correspondingly makes it difficult to adapt these devices to small working machines (SGM). Furthermore, the operation requires a high level of training, so that the application is usually only justified for complex tasks.

Applications of such industrial robots—sometimes with fewer axes—are shown, for example, in WO 2018/235430A1 in the form of a polishing system for railway wagons. JP 04115885 A discloses a handling system for workpieces with a manipulation arm having three rotational axes R¹R²R³ movable on a linear axis T¹. Since this device does not have a linear vertical axis, the boom arms movably driven by the rotational axes would also have to be comparatively long for a sufficiently high handling space. This in turn leads to a higher design effort for the weights of the arms to be kept under control and, if necessary, losses in the load-bearing capacity of the handling device.

Finally, DE 39 07 331 A1 shows a palletizing robot in which two rotational axes R¹R² are suspended from a translational axis T¹ in order to be able to easily reach a lifting table placed underneath the crossmember with the axis T¹ for palletizing printed products. However, such a construction basically cannot be used for handling workpieces that are to be removed from an injection moulding machine, for example, since the space under the crossmember is occupied by the mould plates of the injection moulding machine.

### SUMMARY OF THE INVENTION

Given the described problems of the prior art, it is an object of the invention to provide a component handling device for component handling in working or process machines, which is improved without practical additional mechanical effort with respect to a wide variety of properties, such as lower susceptibility to lubricant contamination, lower risk of collision during component removal, greater flexibility during component removal, higher payload and energy efficiency, larger working space and many more.

This object is achieved by a component handling device for component handling in working or process machines, in particular injection moulding machines. Accordingly, the object of the invention comprises in its basic concept
a basic linear axis running outside or inside the handling space of the handling device,
a multi-axis arrangement translationally displaceable on the basic linear axis with
   a main rotational axis orthogonal to the basic linear axis,
   a secondary rotational axis directed parallel thereto and linked to the main rotational axis via a first robot arm, which guides a second robot arm pivotably over the handling space, and
   a vertical linear axis linked to the second robot arm eccentrically to the secondary rotational axis, and
a gripping device linked to the vertical linear axis for a component to be handled.

In the axis nomenclature introduced at the beginning, the arrangement according to the invention is to be indicated as T¹R¹R²T^{2.} Here, the second translational axis T² in the arrangement T¹T²T³R¹ described at the beginning is replaced by the two rotational axes R¹R², which are arranged in parallel succession at a distance above the first robot arm. Further, the arrangement of the second, vertical translational axis T² in the arrangement T¹R¹R²T² according to the invention is carried out by the second robot arm eccentrically to the rotational axis R^{2,} whereby the translational axis can carry out a generally circular movement about the second rotational axis. Thus, an orientation change of the gripping tool combined with a position change is possible. This eliminates the need to use mechanically sensitive ball bearing screws as combined axial-rotational axes for an orientation change of the gripping tool, as is the case with the SCARA robots described at the beginning.

Since in the arrangement according to the invention the second rotational axis R² guides only the second linear axis T² over the handling space, the number of open lubrication points there is thus reduced by a ratio of 2 to 1 compared with the prior art, and thus the risk of contamination is considerably reduced.

Compared to the kinematic chains T¹T²T³R¹ and T¹R¹T²R²R³ discussed at the beginning, in the object of the invention, the arrangement of the rotational axis R² in front of the translational axis T² in the kinematic chain does not increase the tendency to oscillate due to the aforementioned pendulum effect and thus there is no payload reduction at the translational axis T². This results in an improved energy balance.

Due to the eccentric link of the vertical linear axis T² to the handling device according to the invention, there is no collision contour on the structure supporting the gripping tool so that, in particular in the case of long, vertical components, their handling cannot be disturbed.

A further advantage of the axis conception according to the invention is the extension of the working space thus obtained, which, for example, may extend in an oval shape around the entire linear axis T¹ with respect to the kinematic chain T¹T²T³R^{1,} whereby the working space is extended laterally and also rearwardly without the basic dimensions of the robot structure having to increase.

From the foregoing, it becomes clear that a plurality of advantages over prior art handling robot concepts are achievable by the component handling device design according to the invention using the kinematic chain T¹R¹R²T².

Preferred further embodiments of the component handling device according to the invention are indicated further on. For instance, the basic linear axis T¹ runs sensibly horizontally, wherein in the application of the handling device for component removal from an injection moulding machine the basic linear axis T¹ can be arranged in different arrangements relative to the working space of the injection moulding machine, such as, for example, transversely or parallel to the clamping direction of the injection moulding machine, on the operator or non-operator side of same and on the fixed tool clamping plate or in the region of the movable tool clamping plate. This ensures optimum adaptability of the handling space to the spatial conditions in a production hall and accessibility of the handling space between the open tool clamping plates and laterally thereof for depositing the components removed from the mould.

In a preferred further development of the object of the invention, the effective length of the first robot arm may be a multiple, in particular at least three times, preferably at least four times, particularly preferably at least five times, the effective length of the second robot aim. Due to this length, in conjunction with the displaceability of the first rotational axis along the first translational axis, a comparatively large area can be covered by the handling device.

In an advantageous manner, the vertical linear axis T² linked to the second robot arm may further comprise a guide fixedly attached to the second robot arm, in which a vertical guide crossmember is displaceably mounted. This effectively prevents a risk of collision of a component held on the gripping tool with a structure of the handling device.

In order to achieve five degrees of freedom in the handling device according to the invention, in contrast to the kinematic chains T¹T²T³R¹ and T¹R¹T²R²R³ according to the prior art, it is sufficient to add a pivot rotational axis at the lower end of the vertical linear axis. Each time the latter moves in the earth gravity field, only this rotational axis has to be moved along with it, which in turn benefits an improved energy balance.

Finally, the invention relates to an injection moulding machine comprising an injection unit, a clamping unit having a fixed tool clamping plate and a movable tool clamping plate, and a handling device according to the invention discussed above.

Further features, details and advantages of the invention will be apparent from the following description of an exemplary embodiment with reference to the accompanying drawings.

### BRIEF DESCRIPTION OF THE DRAWINGS

FIG. 1 shows a perspective schematic representation of a component handling device,

FIG. 2 shows a top view onto the open tool clamping plates of an injection moulding machine with a coupled component handling device in an exemplary set-up situation,

FIGS. 3 and 4 show a side view and a top view of the component handling device according to FIG. 2,

FIG. 5 shows a side view of an injection moulding machine with a coupled component handling device during the component removal process,

FIG. 6 shows a schematic top view onto a handling device with the theoretical working space drawn in,

FIG. 7 shows a compilation of top views, analogous to FIG. 2, of various relative positions of the handling device to the injection moulding machine, and

FIG. 8 shows a side view analogous to FIG. 5 with a component handling device according to the prior art.

### DESCRIPTION OF THE PREFERRED EMBODIMENT

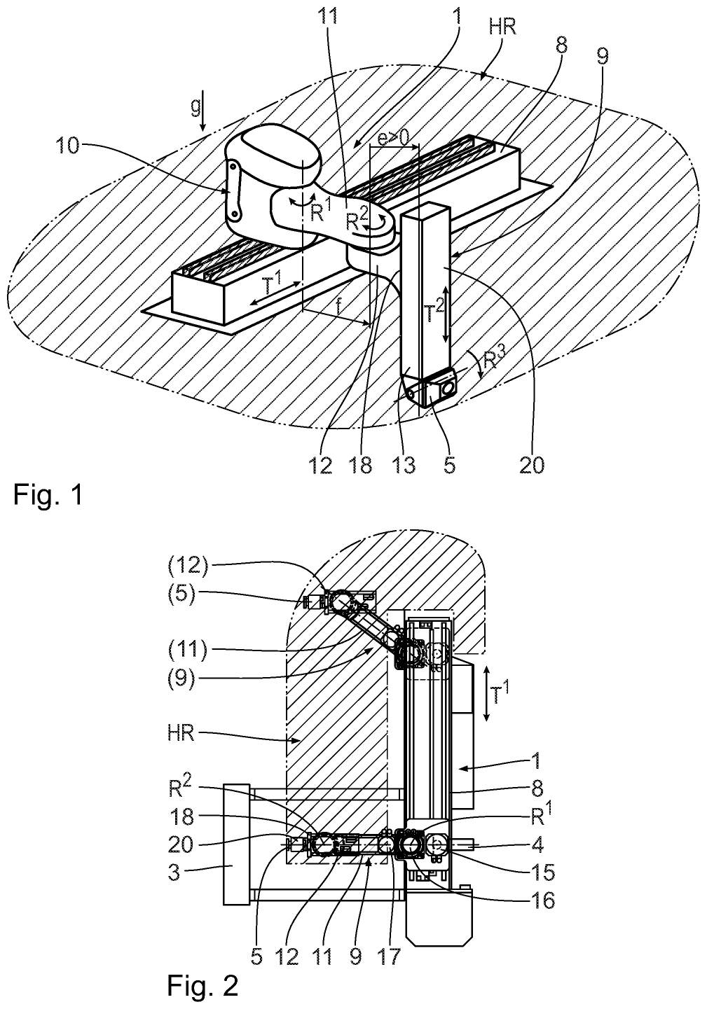

As becomes clear from FIG. 1, the handling device 1 shown comprises a horizontal basic linear axis T¹ formed by a longitudinal guide 8. A type of SCARA robot is mounted thereon as a multi-axis arrangement 9 so as to be translationally displaceable in the direction of this axis. The displacement drive, which is not shown, takes place, for example, via electric motor-gear units in combination with toothed belts or toothed racks, or directly via linear motors in the longitudinal guide 8. The multi-axis arrangement 9 comprises a base head 10, in which the drive for a first vertical main rotational axis R¹ is accommodated. Via a first robot arm 11, at a distance f from the main rotational axis R¹, a secondary rotational axis R², which is also vertical and thus parallel to the main rotational axis R¹, is linked, which in turn, by means of a corresponding drive, guides a second robot arm 12 pivotably over the handling space HR, the horizontal extent of which is indicated by hatching in FIG. 1.

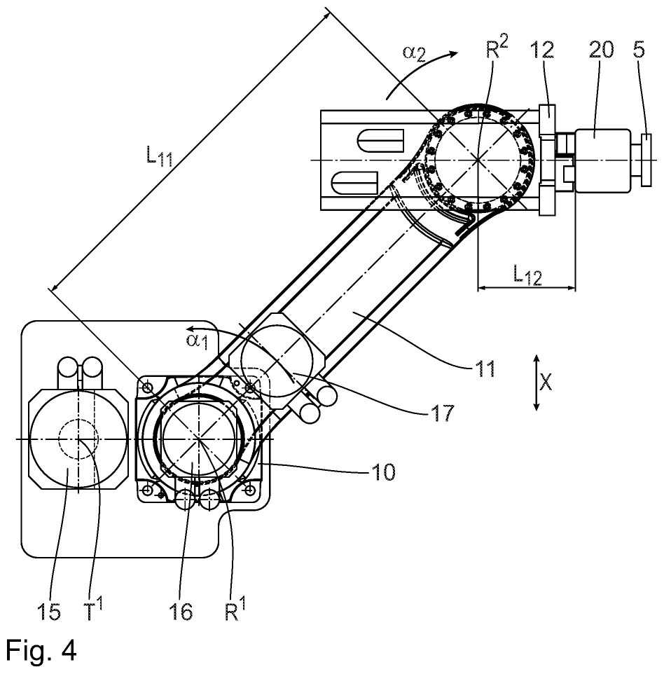

A vertical linear axis T², to be discussed in greater detail with reference to FIG. 3, is linked to the second robot arm 12 with an eccentricity e. A gripping tool 5 for a component not shown in greater detail in FIG. 1 is linked to the lower end 13 of the vertical linear axis T² via a third, horizontal pivot rotational axis R^{3.}

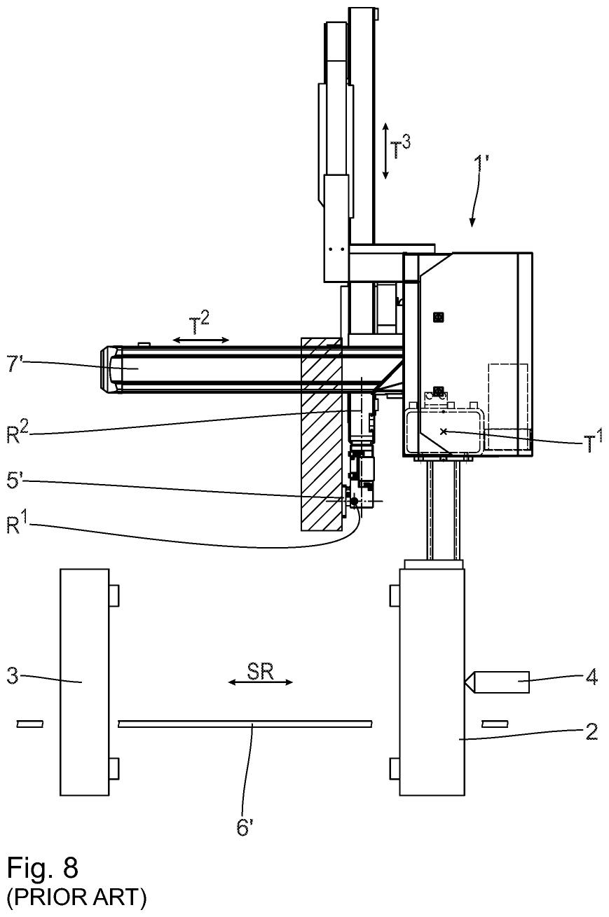

With the aid of the handling device 1 shown in FIG. 1, a component can be manoeuvred within the handling space HR in the earth gravity field g by means of the gripping tool 5 by an appropriately program-supported path control, in order, for example, to remove an injection-moulded component from an open mould and to deposit it on a support, such as the carrier 6′ according to FIG. 8.

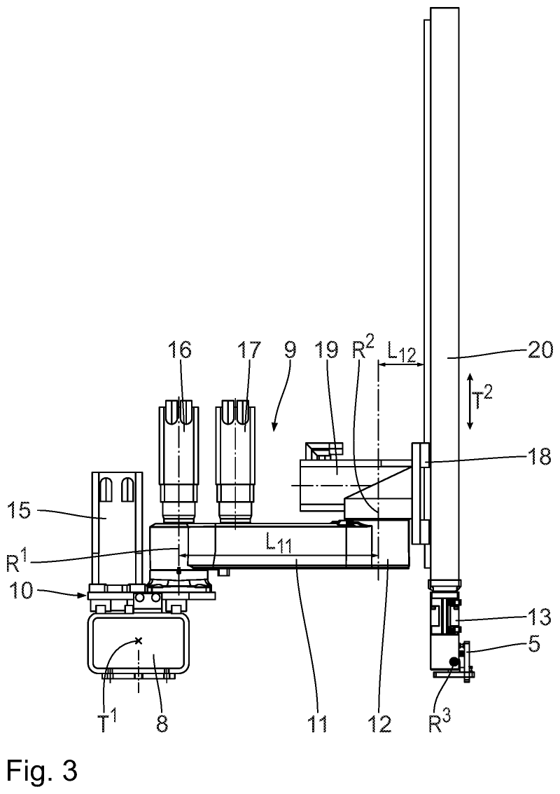

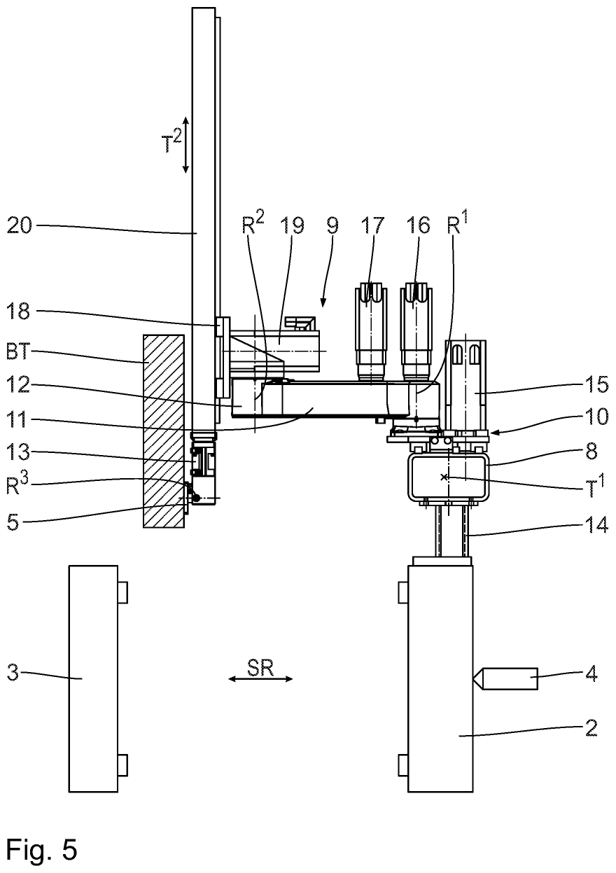

In FIGS. 2 to 5, the handling device 1 is shown in an embodiment and application close to reality. It is coupled via a socket 14 on the fixed clamping plate 2 of the injection moulding machine also drawn in FIGS. 2 and 5, wherein the basic linear axis T¹ runs parallel to the plane of the clamping plate 2, i.e. transversely to the clamping direction SR clamping platens 2, 3. In the corresponding longitudinal guide 8, the base head 10 is guided for longitudinal displacement by means of a corresponding drive motor 15. On the base head 10, the first robot arm 11 is mounted as to be pivoted about the main rotational axis R¹ by means of a drive motor 16. At the free end of the robot arm 11 the secondary rotational axis R² is arranged, by means of which the second robot arm 12 is driven pivotably mounted via a further drive motor 17. The effective length L₁₁ of the first robot arm 11 corresponds to approximately five times the effective length L₁₂ of the second robot arm 12.

The vertical linear axis T² is arranged at the free end of the second robot arm 12. As can be seen in particular from FIG. 3, the guide 18 of this linear axis T² with its drive motor 19 is fixedly arranged at the second robot arm 12 and guides the vertical guide crossmember 20 of the linear axis T². Finally, at the lower end 13 of this crossmember 20, the pivot rotational axis R³ is mounted, by means of which the gripping tool 5 can pivot about a horizontal axis for changing the orientation of a component held by it.

As becomes clear from FIG. 5, for example, a component BT which is very protruding in the vertical direction can be gripped with the aid of the gripping tool 5 and moved upwards out of the intermediate space between the clamping plates 2, 3 without any risk of collision, since no part of the handling device 1 protrudes beyond the front side of the guide crossmember 20. Overall, as indicated in FIG. 2 by two different positions of the multi-axis arrangement 9 and in FIG. 4, the handling space HR outlined in hatched lines in FIG. 2 can be reached by the gripping tool 5 by appropriate control of the basic linear axis T¹ in the X-direction and the two rotational axes R¹, R² in the rotational directions α₁, α₂. This handling space—unlike the handling space in handling devices 1′ according to the prior art—also extends laterally of the basic linear axis and to the rear side of the longitudinal guide 8.

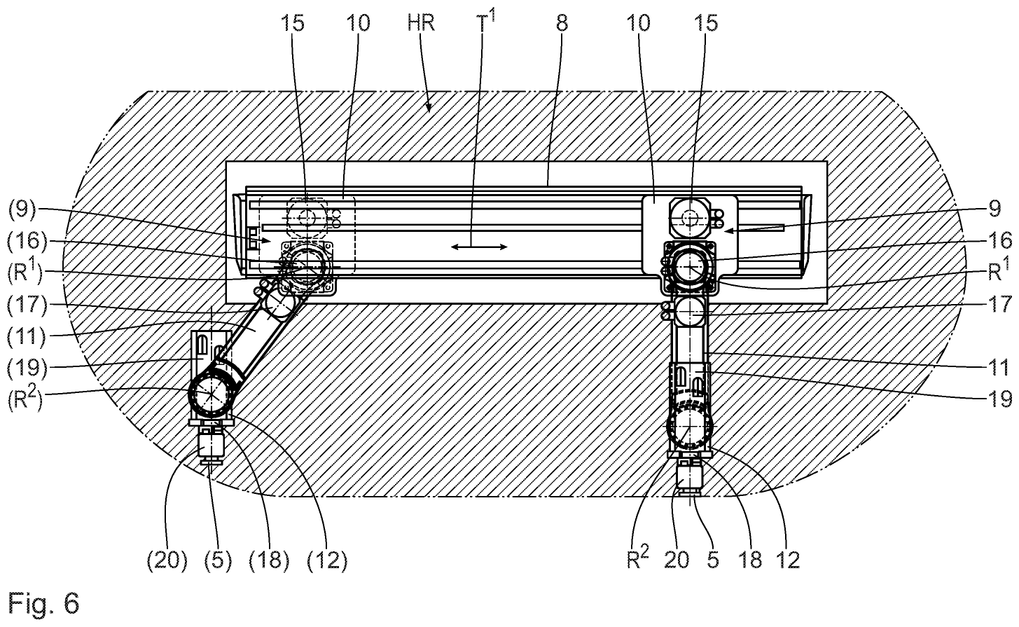

In FIG. 6, an illustration analogous to FIG. 2 is shown without the fixed clamping plate of an injection moulding machine, wherein in this case the handling space HR at the rear side of the longitudinal guide 8 is located around same. This represents the maximum theoretical handling space HR of the handling device 1 shown.

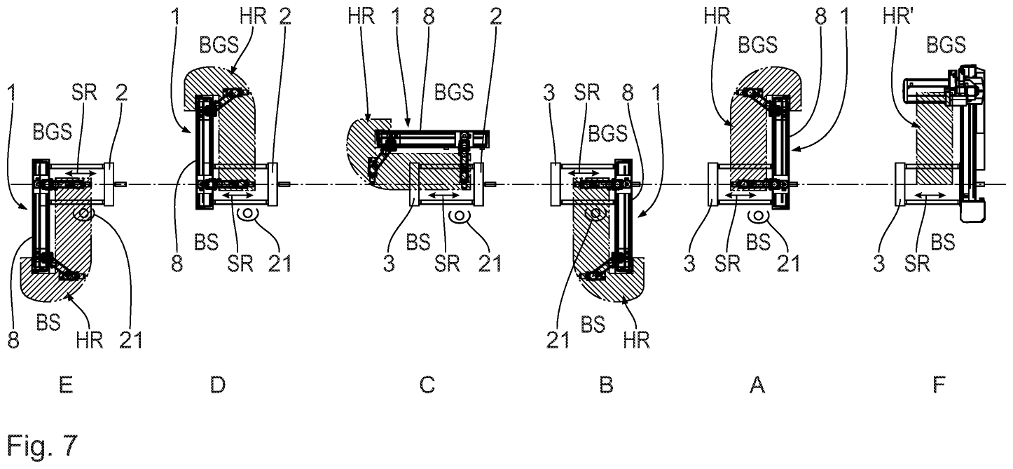

In FIG. 7 A to E, different arrangement variants of the handling device 1 according to the invention relative to an injection moulding machine with its fixed and movable clamping plates 2, 3 are shown.

Partial figure A corresponds to FIG. 2. Here, the component is deposited on the non-operator side BGS of the machine.

In partial figure B, the entire arrangement is mirrored about the central axis of the injection moulding machine when the longitudinal guide 8 is arranged transversely to the clamping direction SR, so that the component is deposited on the operator side BS of the injection moulding machine. In this arrangement, the machine operator 21 indicated in the drawing is protected by appropriate measures, such as a grid enclosure or the like.

In the arrangement according to partial figure C, the longitudinal guide 8 is positioned parallel to the clamping direction SR of the injection moulding machine on the non-operator side BGS. As a result, spatial constraints in terms of width can be met.

In partial figures D and E, the longitudinal guide 8 of the handling device 1 is elevated transversely to the clamping direction SR in each case in the region of the open, movable clamping plate 3 above the latter in such a way that the handling space HR extends either to the non-operator side BGS (FIG. 7 D) or the operator side BS (FIG. 7 E). In the latter case, protective measures are again provided for the machine operator 21.

For the sake of completeness, reference should also be made to FIG. 7 F, in which the handling device 1′ according to the prior art shown in FIG. 8 is illustrated with its significantly smaller handling space HR′ with significantly larger space requirements of the multi-axis arrangement.

In summary, a large number of advantages can be mentioned for the handling device 1 shown, in particular when used on plastic injection moulding machines:
optimised component removal with small injection moulding machines and low hall heights
no interfering contours above the plasticizing unit with the same personal safety
higher payload (e.g. >20%) on the vertical axis
greater flexibility due to lateral and also rear side component handling
smaller dead zones of the handling device due to the vertical arrangement of the drive motors 15, 16, 17
larger working space (e.g. >46%) due to the axis overlays according to the invention
higher dynamics due to a vectorial velocity overlay in the X-direction by the axes T¹R¹
the number of axes with open linear guides is significantly reduced with a proportionally corresponding reduction in the risk of contamination of the tool and the component depositing region
higher energy efficiency due to lower material input and the reduction of cyclically moving masses in the earth gravity field g.

1.- 10. (canceled)

11. A component handling device for component handling in working or process machines, comprising
a basic linear axis (T¹) running outside or inside a handling space (HR) of the handling device,
a multi-axis arrangement (9), which is translationally displaceable on the basic linear axis (T¹), with
a main rotational axis (R¹) orthogonal to the basic linear axis (T¹),
a secondary rotational axis (R²) directed parallel thereto and linked to the main rotational axis (R¹) via a first robot arm (11), which guides a second robot arm (12) pivotably over the handling space (HR), and
a vertical linear axis (T²) linked to the second robot arm (12) eccentrically to the secondary rotational axis (R²), and
a gripping device (5) linked to the vertical linear axis (T²) for a component (BT) to be handled.

12. An injection moulding machine comprising the component handling device according to claim 11.

13. The handling device according to claim 11, wherein the handling space (HR) extends in an oval-shaped manner at least partially around the basic linear axis (T¹).

14. The handling device according to claim 11, wherein the handling space (HR) extends in an oval-shaped manner around the entire basic linear axis (T¹).

15. The handling device according to claim 11, wherein the basic linear axis (T¹) runs horizontally.

16. The handling device according to claim 11, for removing components from an injection moulding machine, wherein the basic linear axis (T¹) is arranged transversely or parallel to the clamping direction (SR) on the operator side or non-operator side of the injection moulding machine and in the adjustment range of the movable clamping plate (3).

17. The handling device according to claim 11, for removing components from an injection moulding machine, wherein the basic linear axis (T¹) can be coupled on a fixed clamping plate (2) of the injection moulding machine.

18. The handling device according to claim 11, wherein an effective length (L₁₁) of the first robot arm (11) is a multiple of an effective length (L₁₂) of the second robot arm (12).

19. The handling device according to claim 18, wherein the effective length (L₁₁) of the first robot arm (11) is at least three times the effective length (L₁₂) of the second robot arm (12).

20. The handling device according to claim 18, wherein the effective length (L₁₁) of the first robot arm (11) is at least four times the effective length (L₁₂) of the second robot arm (12).

21. The handling device according to claim 18, wherein the effective length (L₁₁) of the first robot arm (11) is at least five times the effective length (L₁₂) of the second robot arm (12).

22. The handling device according to claim 11, wherein the vertical linear axis (T²) linked to the second robot arm (12) has a guide (18) which is fixedly attached to the second robot arm (12) and in which a vertical guide crossmember (20) is displaceably mounted.

23. The handling device according to claim 11, wherein the gripping device (5) is linked to the vertical linear axis (T²) by means of a pivot rotational axis (R³) mounted at one end of the vertical linear axis (T²) of the multi-axis arrangement (9) and orthogonal thereto.

24. The handling device according to claim 23, wherein the gripping device (5) with the pivot rotational axis (R³) is arranged at the lower end (13) of the vertical linear axis (T²).

25. An injection moulding machine, comprising
an injection unit,
a clamping unit with a fixed and a movable tool clamping plate (2, 3), and
the handling device (1) according to claim 11.
